(19) United States
(12) Patent Application Publication
(10) Pub. No.: US 2011/0048202 A1
(43) Pub. Date: Mar. 3, 2011

(54) SAW WITH DIGITAL MEASUREMENT DEVICE

(75) Inventors: Robert Dean Peterson, Evanston, IL (US); Matthew Michael Rybka, Hoffman Estates, IL (US)

(73) Assignees: CREDO TECHNOLOGY CORPORATION, Broadview, IL (US); ROBERT BOSCH GMBH, Stuttgart (DE)

(21) Appl. No.: 12/551,060

(22) Filed: Aug. 31, 2009

(51) Int. Cl. B26D 7/28; B27B 5/20

(52) U.S. Cl. 83/471.2; 83/522.18

(57) ABSTRACT

A saw comprises a blade configured to perform a cut on a work piece at a cutting position. The saw includes a measurement device configured to determine a distance. The measurement device includes a laser generator configured to emit a laser beam. A laser interference member is provided on the work piece with a portion of the laser interference member in the path of the laser beam. The laser interference member comprises a reflective surface configured to reflect the laser beam and an adhesive surface configured to adhere to the work piece. A digital display provides an indication of the determined distance. In another embodiment, the measurement device is provided as a sensor wheel associated with the engagement surface. The sensor wheel is configured to rotate when the work piece is moved along the engagement surface and determine a distance the work piece has moved along the engagement surface.

### FIELD

This application relates to the field of power tools and more particularly to power saws, such as power miter saws.

### BACKGROUND

Power saws, such as miter saws are typically used for cutting a work piece, for example, construction lumber. A miter saw typically include a base or platform on which a turntable is positioned. The turntable is used to support the work piece to be cut. A cutting assembly is connected to the turntable and is operable to perform a cutting operation on the work piece. The cutting assembly is configured to move upward and away from the turntable and downward toward the turntable in order to produce a cut. The cutting assembly is also configured to pivot in relation to the turntable in order to produce angled cuts.

A rip fence typically extends above the surface of the turntable. The rip fence includes a scale that allows the user to determine how far the work piece extends past the location of the cut. However, very long work pieces may extend past the end of the rip fence, making it difficult for the user to determine how far the end of the work piece is from the location of the cut.

In view of the foregoing, it would be desirable to provide a saw with an improved measurement device. It would also be desirable if such measurement device could be easily incorporated into a miter saw or a table saw. While it would be desirable to provide a saw that provides one or more of these or other features, the teachings disclosed herein extend to those embodiments which fall within the scope of the appended claims, regardless of whether they accomplish one or more of the above-mentioned advantages or include one or more of the above-mentioned features.

### SUMMARY

A saw comprises a blade configured to perform a cut on a work piece at a cutting position. The saw includes a measurement device configured to determine a distance. The measurement device includes a laser generator configured to emit a laser beam. A laser interference member is provided on the work piece with a portion of the laser interference member in the path of the laser beam. The laser interference member comprises a reflective surface configured to reflect the laser beam and an adhesive surface configured to adhere to the work piece. The measurement device further comprises a digital display configured to provide an indication of the determined distance.

In at least one embodiment, the saw is a miter saw. The miter saw comprises a table providing a surface for supporting the work piece. The cutting position is defined by a slot in the table, and the blade is configured to engage the slot. The blade is supported by a pivotable cutting arm. The pivotable cutting arm is configured to move the blade into the slot when the blade performs the cut. The miter saw further comprises a rip fence positioned above the table. The laser generator may be positioned on the rip fence.

In another embodiment, the measurement device is provided as a sensor wheel associated with the engagement surface. The sensor wheel is configured to rotate when the work piece is moved along the engagement surface. The measurement device is configured to determine a distance the work piece has moved along the engagement surface based upon rotation of the sensor wheel. The digital display provides an indication of the determined distance. The engagement surface may be a table of the saw, a rip fence, or any other work support engaging surface.

The above described features and advantages, as well as others, will become more readily apparent to those of ordinary skill in the art by reference to the following detailed description and accompanying drawings. While it would be desirable to provide a saw that provides one or more of these or other advantageous features, the teachings disclosed herein extend to those embodiments which fall within the scope of the appended claims, regardless of whether they accomplish one or more of the above-mentioned advantages or include one or more of the above-mentioned features.

### BRIEF DESCRIPTION OF THE DRAWINGS

FIG. 1 shows a front perspective view of one embodiment of a saw with a digital measurement device with a cutting assembly of the saw in a down position;

FIG. 2 shows a front view of a laser interference device for use with the digital measurement device of FIG. 1;

FIG. 3 shows the saw of FIG. 1 with the cutting assembly in an up position;

FIG. 4 shows the saw of FIG. 3 with a work piece supported by the saw and a reflector positioned on an end of the work piece;

FIG. 5 shows an alternative embodiment of the saw of FIG. 1 with the digital measurement device positioned above the rip fence;

FIG. 6 shows an alternative embodiment of the saw of FIG. 1 with the digital measurement device provided as a roller provided on a table surface of the saw;

FIG. 7 shows the saw of FIG. 5 with the cutting assembly in an up position; and

FIG. 8 shows an alternative embodiment of the saw of FIG. 6 with the digital measurement device provided as an optical measurement device provided on the table surface of the saw.

### DESCRIPTION

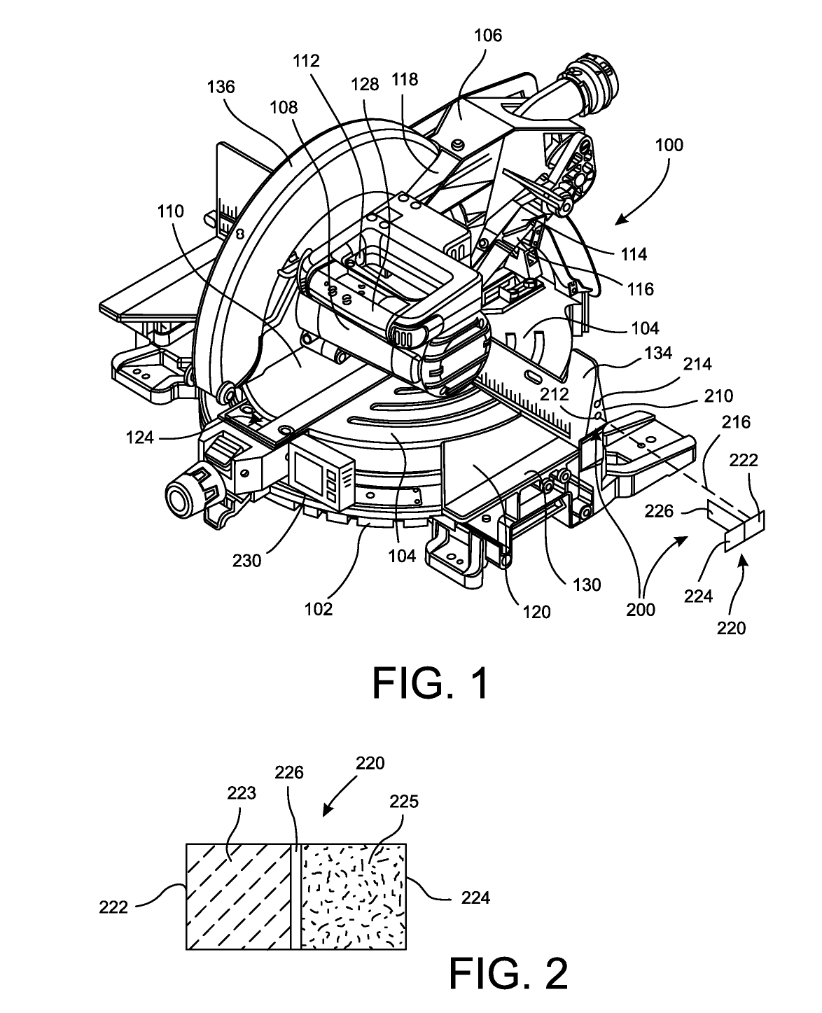

Referring now to FIGS. 1-4, there is shown a miter saw assembly 100. The miter saw assembly 100 includes a digital measurement device 200 positioned thereon. The miter saw 100 comprises a base 102 and a turntable 104 that is rotatable on the base 102. The miter saw assembly 100 further includes a cutting head 106 mounted on a cutting head support assembly 114. The cutting head 106 (which may also be referred to herein as a “cutting assembly”) includes a motor 108 that is operable to rotate a circular saw blade 110. The cutting head support assembly 114 is attached to the turntable 104 and configured to support the cutting head 106 such that the cutting head may move over the turntable 104 and perform cutting operations.

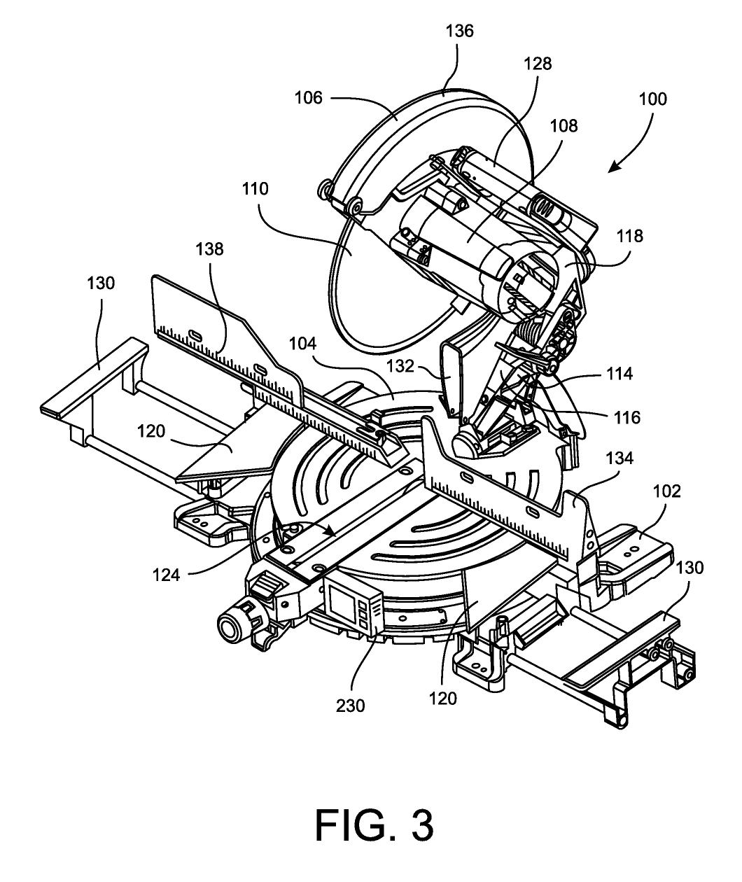

The cutting head support assembly 114 includes a bevel arm 116 pivotably connected to a cutting arm 118. The bevel arm 116 (also referred to herein as a “bevel post”) provides a bevel support structure for the miter saw assembly. The bevel arm 116 is pivotally attached to the turntable 104. The bevel arm is configured to pivot from a vertical position (as shown in FIG. 3) to an angle of 45° (not shown) prior to a cutting operation. This pivoting allows the blade 110 of the cutting assembly 106 to approach the table 104 from a bevel angle and perform angled cuts, as is well known in the art.

The cutting arm 118 of the support assembly 114 provides a support for the cutting assembly 106. The cutting arm 118 is configured to pivot upward and downward in relation to the turntable 104 and the base 102 during a cutting operation, as is well known in the art. FIG. 1 shows the cutting arm 118 in a downward position and FIG. 3 shows the cutting arm 118 in the upward position.

The cutting assembly 106 includes a handle 128 connected to the cutting arm 118 to facilitate movement of the cutting assembly 106 in relation to the turntable 104. The handle 128 is designed and dimensioned to be grasped by a human hand when performing a cutting operation. This allows the user to easily pivot the cutting assembly 106 upward and downward. A switch 112 is provided on the handle 128 to allow the user to easily energize and de-energize the electric motor 108 during a cutting operation. A blade guard 136 covers the top portion of the circular saw blade 110.

The circular saw blade 110 includes a generally circular plate having a central opening defined therein. A plurality of cutting teeth are attached to periphery of the plate, as is well known in the art. A dust chute 132 is positioned behind the blade 110 when the blade is in a downward cutting position. In this manner, the dust chute 132 receives sawdust and other debris created by the blade 110 when performing a cutting operation.

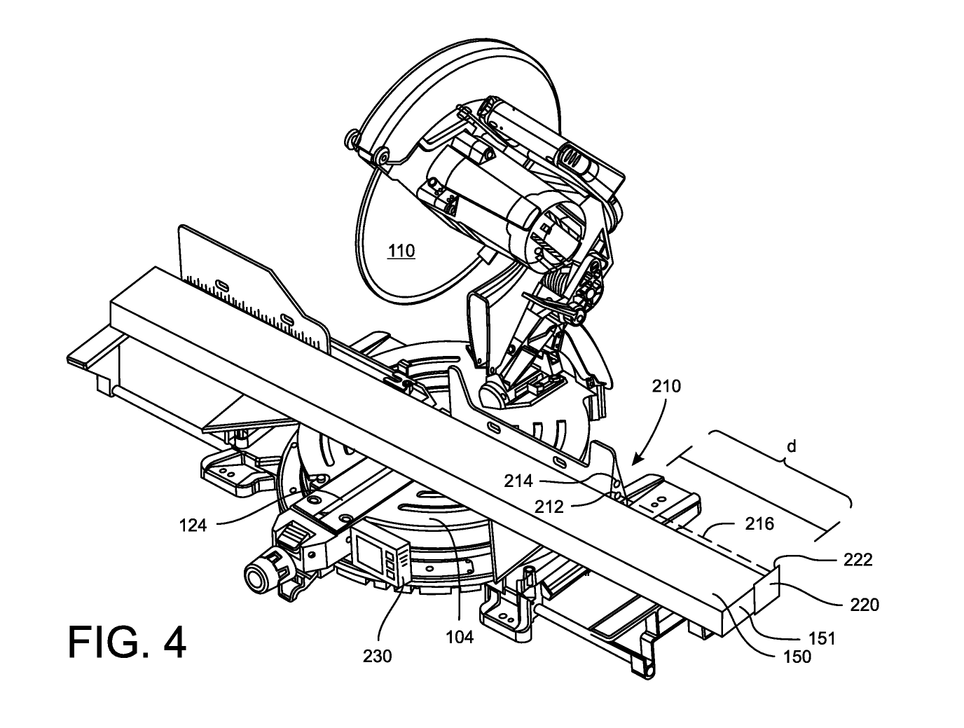

The circular saw blade 110 is used to cut a work piece 150 (see FIG. 4) positioned on the table 104. The table 104 provides a work surface that supports the work piece 150. A slot 124 is formed in the table at a cutting location. The blade is configured to engage the slot during a cutting operation. In the embodiment of FIGS. 1-4, the slot 124 provides a void for the blade when the blade 110 completes a cut through the work piece 150, thus preventing the blade from coming into contact with the table 104.

A stationary table leaf 120 is provided adjacent to the turntable 104. Another leaf is also provided on the opposite side of the turntable. The leaves 120 do not rotate with the turntable, and remain to the lateral sides of the saw 100. The leaves 120 provide an additional support surface that may be used to support the work piece during a cutting operation.

Moveable work surface extensions 130 (which may also be referred to herein as “support extensions”) are provided to the outward side of the leaves 120. The support extensions 130 are moveable from a retracted position (as shown in FIG. 1) where the support extensions 130 are in close proximity to the leaves 120 to an extended position (as shown in FIG. 2) where the support extensions 130 are removed from the leaves 120. When in the extended position, the support extensions 130 provide an additional support surface for elongated work pieces (as shown in FIG. 3).

A rip fence 134 is secured to the base 102 and positioned over the turntable 104. The rip fence 134 provides a surface for aligning a work piece thereon, as shown in FIG. 4. The rip fence 134 also includes a scale 138. The scale 138 provides an indication of the distance a work piece 150 extends from the cutting position (i.e., the slot 124). The scale 138 may also be used during a cutting operation to move a work piece a given distance in preparation for an additional cut.

The miter saw 100 includes a digital measurement device 200 positioned thereon. In the embodiment of FIGS. 1-4, the digital measurement device 200 includes a laser rangefinder 210, a laser interference device 220, and a digital display 230.

The laser rangefinder 210 may be configured similar to any of various laser rangefinders known in the art. Such laser rangefinders typically include a laser generator, optics, a light detector, and associated electronics. The laser rangefinder 210 makes use of the generated laser beam to determine the distance to a reflective target. In particular, the laser rangefinder operates on the time of flight principle by sending a laser pulse in a narrow beam towards the reflective target and measuring the time taken by the pulse to be reflected off the target and returned to the rangefinder. In order to ensure that only light from the laser generator is detected by the rangefinder, the laser is typically pulsed with a predetermined code.

In the embodiment of FIG. 1, the laser rangefinder 210 is provided on the rip fence 134. The laser generator and associated electronics are contained within a protective housing provided by an end portion of the rip fence 132. Two optical lenses 212, 214 are shown on the rip fence. One of the lenses 212 is used to emit a laser beam 216 (shown by the dotted line in FIG. 1) in a direction extending generally away from the blade 110. In particular, the laser generator and optical lens 212 emit the laser beam 216 in a direction that is substantially perpendicular to the flat side surface of the blade 110. The other optical lens 214 is used to receive reflected laser light and direct such light to the light detector within the protective housing of the laser generator 210. Even though the laser 216 is represented in FIG. 1 as a dotted line, it will be recognized that the laser may be configured to cover a wider area, such as a thin cone-shaped laser.

A typical work piece being cut on a miter saw is a long thin material with constant cross-section, such as the work piece 150 shown in FIG. 4. With such work pieces, there is no natural surface for the laser 216 to reflect from. Thus, the digital measurement device 200 includes a separate reflective component from the laser rangefinder 210. In the embodiment of FIGS. 1-4, this separate reflective component is the laser interference device 220 which is configured for attachment to the end of the work piece 150. The laser interference device 220 includes a reflective surface that extends away from the work piece and is designed to reflect laser light back toward the light detector of the laser rangefinder 210.

In the embodiment of FIGS. 1-4, the laser interference device 220 is provided in the form of a “T” shaped part. The part is generally comprised of a relatively lightweight plastic material, but may also be formed from any of various other materials, including wood or metals.

As best shown in FIGS. 1 and 2, the “T” shaped part 220 includes three wings, 222, 224 and 226. One wing 222 includes a reflective surface 223. The reflective surface 223 may be any surface capable of reflecting light from the laser beam 216 back to the laser rangefinder 210. In at least one embodiment, the reflective surface 223 is a mirrored surface.

A second wing 224 includes an attachment surface 225 capable of securing the laser interference device 220 to the work piece 150. In one embodiment, the attachment surface 225 is an adhesive surface including a low-tack, reusable pressure sensitive adhesive, such as the adhesive commonly used on office sticky notes. This adhesive allows the attachment surface 225 to be easily attached to the work piece 150 and easily removed from the work piece. In the event the adhesive surface 225 wears away over time, the user may use two-sided tape on the second wing 224 in order to provide continued adhesive properties.

The third wing 226 of the “T” shaped part 220 extends perpendicular to the first wing 222 and the second wing 224. The third wing 226 may be smooth and clean on both opposing surface or may include at least one an adhesive surface similar to surface 225. Such an additional surface may be used to provide additional adhesive properties to the part 220 and/or allows the part to be attached to the work piece 150 in additional orientations. In at least one embodiment, the third wing also includes an additional reflective surface. Such an additional reflective surface allows the “T” shaped part to easily reflect the laser 216 in different orientations.

FIG. 4 shows the “T” shaped part 220 attached to an exemplary work piece 150 with the adhesive surface 225 attached to the distal end 151 of the work piece 150 and the wing 222 with the reflective surface 223 extending outward from the work piece in the path of the laser 216. The laser rangefinder 210 emits the laser 216 from lens 212, in a direction away from the blade 110 and toward the laser interference device 220. The laser 216 may be emitted as a narrow cone or similar shape such that it spreads slightly as it moves away from the laser generator. Thus, user is not required to make a precise directional shot at the reflective device, and some deviation from a straight target line will still allow some laser light to strike the reflective surface 223.

When the detector of the laser rangefinder 210 detects reflected laser light through the lens 214, the electronic circuitry provides a calculation of the distance the reflected light has travelled based on well known time of flight principles. This distance is then added to a known distance between the blade 110 and the laser generator to arrive at a total distance between the blade and the laser interference device at the end of the workpiece 150. The measurement device 200 may be calibrated from the outside edge of the blade to show the actual distance from the blade 110 and associated cutting slot 124 on the table 104. In addition, calibration may be adjusted by the user depending on which part of the cutting kerf the user wants to use.

After the distance from the blade 110 to the edge of the work piece is calculated by the laser rangefinder 210, the distance is displayed on the digital display 230. The digital display 230 may be an LCD screen, LED display, or any other display known to those of skill in the art. The display 230 may include a number of buttons that allow the user to calibrate the display, adjusted options, select modes, or otherwise program the display.

In addition to providing the user with the distance from the blade to the edge of the work piece, the measurement device 200 may also be configured such that the display 230 continuously shows the change in distance as the user adjusts the material on the table 104. For example, consider a situation where a user cuts a 5 foot piece of material from a work piece and wants to remove and additional 1.5 feet from the work piece. The user may accomplish this by aligning the end of the work piece to the edge of the blade and then moving the work piece 1.5 feet as using the display shows the change in distance. In an associated algorithm, the user may select a current position as a “zero” position, and the display is programmed to show movements of the work piece from the “zero” position. Additional algorithms may also be incorporated in the measurement device 200 to calculate various lengths that may be useful to the user such as the lengths of a certain number of divisions. Each additional mode of operation may be selected by the user by selecting the appropriate buttons on the digital display 230.

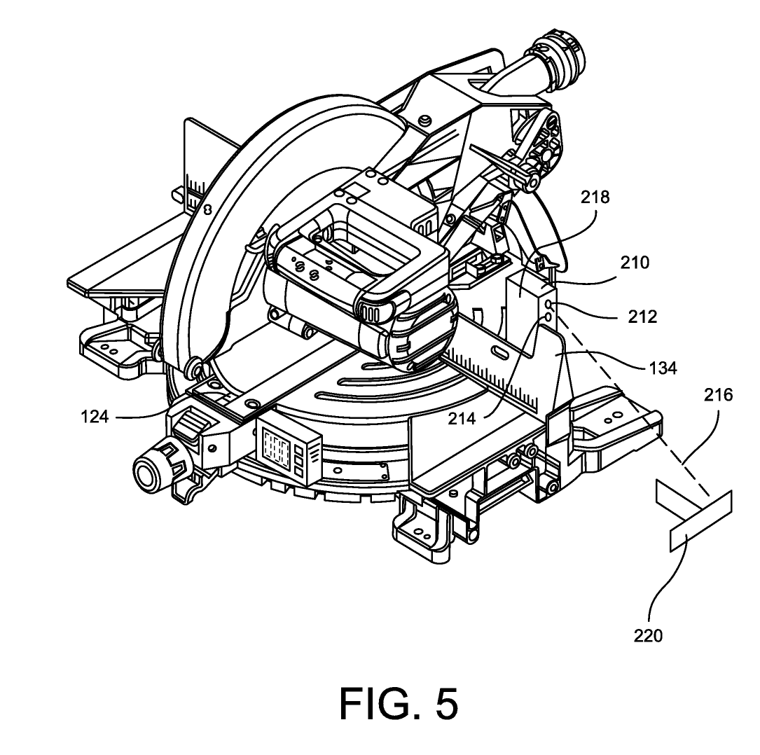

While the laser rangefinder 210 is shown in FIGS. 1, 3 and 4 as contained within an end portion of the rip fence 134, it will be recognized that the laser rangefinder 210 may also be positioned on other locations of the saw. Another possible location for the laser rangefinder is the back of the rip fence 134, as shown in the embodiment of FIG. 5. In this embodiment, the laser rangefinder 210 includes a housing 118 that extends above the rip fence 134. As can be seen in FIG. 5, the laser beam 216 may be directed at a significant angle relative to the work surface 150. Accordingly, the actual distance of travel of the laser beam 216 may not be a true measure of the horizontal distance from the cutting sot 124 and the reflective device 220. Thus, the laser rangefinder 210 may be equipped with a slope feature that allows the measurement device 200 to calculate the horizontal distance along the work piece based on the distance of laser travel and the incline of the laser generator. In at least one embodiment, the laser rangefinder 210 may be tilted on the work piece, allowing the user to orient the laser in the general direction of the reflective device. In this embodiment, the laser rangefinder is capable of determining the angle of laser incline relative to the table 104 and calculating the distance of the work piece 150 based on this incline and the distance of laser travel.

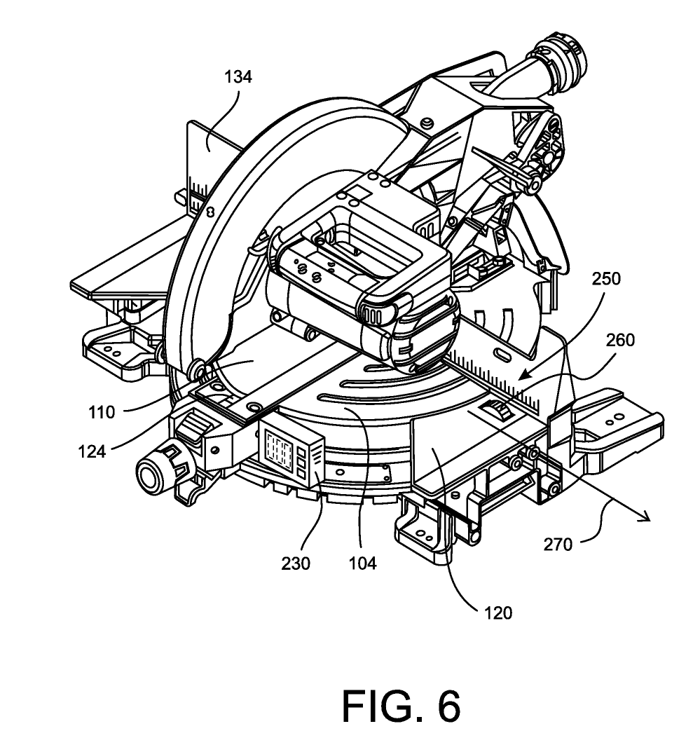

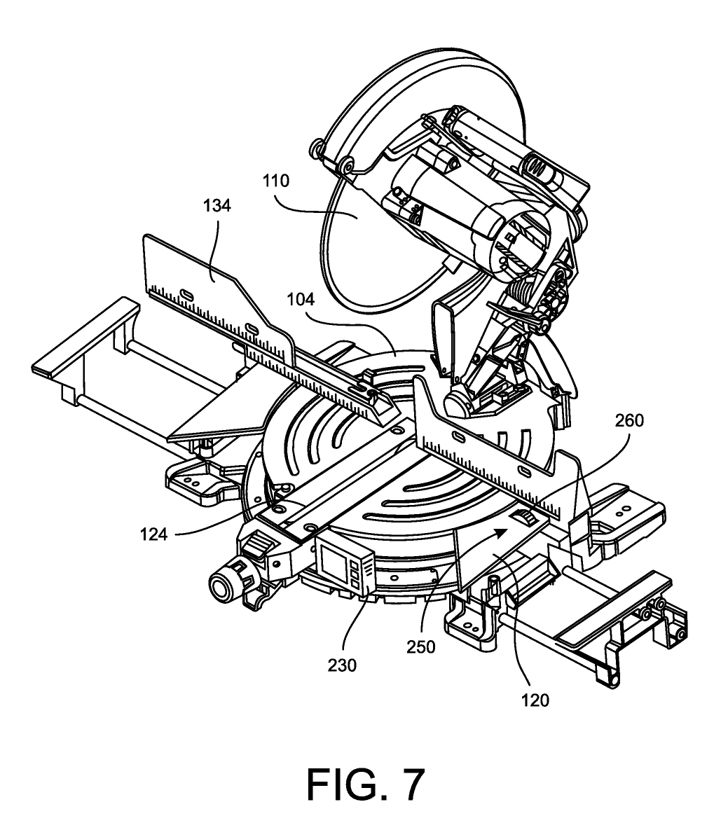

With reference now to FIGS. 6 and 7, in an alternative embodiment, the measurement device 200 comprises a linear measurement device 250 including a measurement wheel 260 positioned on one leaf 120 of the support surface and associated electronics. The device 250 is configured to transform rotational movement of the measurement wheel 260 into a linear measurement that is displayed on the digital display 230.

In the embodiment of FIGS. 6 and 7, the rotatable measurement wheel 260 is rotatably mounted on the table leaf 120 such that a portion of the wheel 260 extends above the support surface provided by the leaf 120. The remainder of the wheel 260 is provided below the support surface. It will be recognized that although the wheel 260 is provided in association with the support surface in the embodiments of FIGS. 6 and 7, the wheel 260 may be positioned differently on the saw in other embodiments. For example, the wheel 260 may be associated with any surface of the saw which the work piece is intended to engage, such as placement of the wheel 260 on the fence 134 or provided as an attachment at the end of the support surface.

The measurement wheel 260 generally includes a high friction outer surface comprised of a rubber, elastomer or similar material configured to grip the surface of various work pieces. The measurement wheel 260 is rotatably mounted on the saw and is connected to electronic measurement circuitry (not shown). The electronic measurement circuitry calculates a linear distance of travel based on rotation of the measurement wheel 260. Similar to the embodiments of FIGS. 1-5, discussed above, the electronic measurement circuitry communicates with the digital display 230 to show the calculated linear distance.

In operation, a user slides a work piece along the support surface and over the measurement wheel 260 in the direction of arrow 270 of FIG. 6. Rotation of the wheel 260 is displayed as the change in linear position of the work piece. In at least one embodiment the measurement device 250 displays the movement of the work piece in 1/16 inch increments.

The display includes various modes of operation. In one mode, the display 230 may show a distance of movement of the work piece from a first position to a second position. In another mode, a user may use the measurement wheel 260 to measure the total distance between an edge of a work piece and the cutting slot 124. In this mode, the user places the edge of the work piece on the wheel and slides the work piece in the direction of arrow 270. As the work piece is moved in direction 270, the wheel rotates, and the accumulated distance is shown on the digital display, plus the distance between the cutting slot 124 and the wheel.

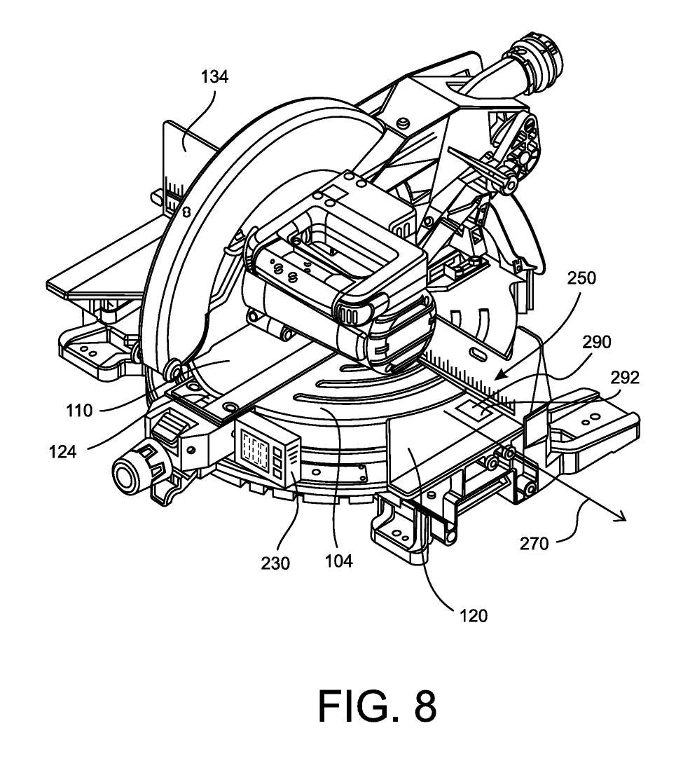

FIG. 8 shows yet another alternative embodiment of the measurement device 200 where the rotatable wheel 260 is replaced with an optical measurement device 290. The optical measurement device 290 may include a light emitting diode or a laser diode, a photo detector, and other electronic devices positioned behind a window 292 on the support surface or other surface associated with the work piece. In FIG. 8, the window 292 is positioned on the leaf 120 and the electronic devices are housed under the leaf 120. Of course, the window may also be provided on another surface associated with an area of the saw where the work piece may move. The optical measurement device is configured to measure the distance of travel of the work piece relative to a point on the window 292. The optical measurement device is configured to operate in a manner similar to an optical mouse. Accordingly, the LED or laser diode illuminates the surface of the work pieces as it moves relative to the window 292. Images of the work piece are captured periodically by the photo detector and changes between one frame and the next are processed by an image processor and translated into movement and distance of travel using an optical flow estimation algorithm.

Although a saw with a digital measurement device has been described with respect to certain preferred embodiments, it will be appreciated by those of skill in the art that other implementations and adaptations are possible. For example, as discussed above, the measurement devices including the laser generator or roller may be differently positioned on the saw. As another example, the measurement display could also be positioned at a different location on the saw. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A saw for cutting a work piece, the saw comprising:
a blade configured to perform a cut on the work piece at a cutting position; and
a measurement device configured to determine a distance, the measurement device including,
a laser generator configured to emit a laser beam, and
a laser interference member provided on the work piece with a portion of the laser interference member in the path of the laser beam.

2. The saw of claim 1 wherein the distance is a distance between the cutting position and the portion of the laser interference member in the path of the laser beam.

3. The saw of claim 1 wherein the measurement device further comprises a digital display configured to provide an indication of the distance.

4. The saw of claim 1 wherein the blade is a circular blade configured to rotate about an axis of rotation and the laser beam extends in a direction substantially parallel to the axis of rotation.

5. The saw of claim 1 wherein the saw further comprises a table providing a surface for supporting the work piece, the cutting position defined by a slot in the table, and the blade configured to engage the slot.

6. The saw of claim 5 where the saw is a miter saw and the blade is supported by a pivotable cutting arm, the pivotable cutting arm configured to move the blade into the slot when the blade performs the cut.

7. The saw of claim 6 further comprising a rip fence positioned above the table, the laser generator positioned on the rip fence.

8. The saw of claim 1 wherein the laser interference member comprises a reflective surface configured to reflect the laser beam.

9. The saw of claim 8 wherein the laser interference member further comprises an adhesive surface configured to adhere to the work piece.

10. The saw of claim 9 wherein the laser interference member is substantially T shaped and includes three wings, wherein the reflective surface is provided on one wing and the adhesive surface is provided on at least one other wing.

11. A saw for cutting a work piece, the saw comprising:
a blade configured to perform a cut on the work piece at a cutting position;
a work piece engagement surface; and
an electronic measurement device positioned on the engagement surface, the electronic measurement device configured to determine a distance the work piece has moved along the engagement surface.

12. The saw of claim 11 wherein the engagement surface is a table comprising a work support surface.

13. The saw of claim 11 wherein the electronic measurement device includes a sensor wheel configured to rotate when the work piece is moved along the engagement surface.

14. The saw of claim 13 wherein the sensor wheel extends through an opening in the work support surface.

15. The saw of claim 11 wherein the electronic measurement device comprises an optical measurement device.

16. The saw of claim 11 wherein the saw is a miter saw and the blade is supported by a pivotable cutting arm, wherein the cutting position is defined by a slot in the table such that the blade is configured to engage the slot, and wherein the pivotable cutting arm is configured to move the blade into the slot when the blade performs the cut.

17. The saw of claim 11 wherein the engagement surface is a rip fence.

18. A miter saw comprising:
a support surface;
a cutting arm configured to pivot relative to the support surface;
a blade provided on the cutting arm;
a laser generator configured to emit a laser beam along a path extending away from the blade, and
a reflective member configured for placement in the path of the laser beam, the reflective member separated from the laser generator by a measurement distance, and
a display configured to show the measurement distance between the laser generator and the reflective member.

19. The miter saw of claim 18 wherein the reflective member includes a reflective surface and an adhesive surface, the adhesive surface configured to adhere to a workpiece.

20. The miter saw of claim 18 wherein the miter saw further comprises a rip fence and the laser generator is positioned on the rip fence.
